(19) United States
(12) Patent Application Publication
(10) Pub. No.: US 2008/0273688 A1
(43) Pub. Date: Nov. 6, 2008

(54) Phone computing machine (PCM)

(76) Inventors: Wei Lu, Bethesda, MD (US); Liping Chen, Bethesda, MD (US)

Correspondence Address: Wei Lu, 6800 Tammy CT, Bethesda, MD, 20817, US

(21) Appl. No.: 11/800,362

(22) Filed: May 5, 2007

(51) Int. Cl. H04M 7/00

(52) U.S. Cl. 379/339

(57) ABSTRACT

The present invention PCM (phone computing machine) uses general purpose programmable device (101) as its core. Line-end interface (201), includes RJ11 jack (210), DAA (212) and CODEC (214), connects to telephone line. User-end interface (301), in one embodiment includes RJ11 jack (310), SLIC (312) and CODEC (314) connects to user apparatus/networks/systems. The functionality of PCM is defined when a portable data storage device with application software is plugged in the machine's external memory interface (401). PCM's great flexibility and low cost will open up new frontier in the telephone system. In addition, a general method similar as PCM can be applied to other cost-effective information processing applications between predetermined information sources. Examples are voice application in microphone system, audio/video processing in home entertain systems.

### BACKGROUND OF THE INVENTION

1. Field of the Invention

The present invention relates to a device operating in-between incoming phone line jack and appropriate local household apparatuses/networks/systems, such as but not limited to other phone jacks, phones, modems, or fax machines etc. The functionality of the device is determined by user application program.

2. Prior Art

In the last century telephone technology has under gone great changes. Telephone local apparatuses were used to be voice only devices, over the years they evolved into devices that covered voice /data and to some extent control functions.

However all current telephone local apparatus like answering machine, modem etc. are designed with the following concepts and assumptions:
1. They are terminals directly connected to the subscriber line.
2. Each user telephone device is designed to have one set of predefined specific functionality.
3. No mutual interactions between the devices are considered.

With user devices all directly connected to the subscriber line or phone jack, it is a big challenge of how to properly operate those devices at the same time. In practice, those devices will generally need the involvement of human intelligence and pose a big limitation of the potential usage of telephone line. For example if you have a fax machine and want to use a regular telephone on the same line, you have to set that the fax machine to be only active after a number of rings. By doing so, you can not expect an incoming fax go directly to the fax machine without ringing the phone. Further more, when you want to add an answer machine to the same line, which generally utilizes the same activation method, you have a problem of using both answer machine and fax machine at the same time. Even with a telephone switch or PBX, this type of problem can not be solved with a single telephone line.

With each of those user devices always be designed and sold as a single function specific device, it is very difficult if ever you want to alter the functionality to adapt to your need. An answer machine you purchased will always be an answer machine with such predetermined functionality and you can not change it to something with different functionality even if they have the exact same physical interface.

With normally no interaction between phone line devices again limits the flexibility and scope of application for those apparatus. Telephone switch or PBX is probably the only one that can have multiple functions built in and connects with multiple phones But it is targeted to be working with multiple input lines/multiple output lines configuration and the switch specific functionality is not suitable for ordinary household use. The cost of PBX is also beyond ordinary household usage.

Of course for each one's specific needs, one can always have a customized system to fully meet them. However if a system can only have a small user base or even a single user, it can not justify the volume of production to bring down the price with current state of art approaches.

In other words, current state of art solutions for consumer device leave either a mass production item with very limited and fixed functionality or a very small volume custom made system that has custom tailed functionality but with very high price.

In the industry people are using field upgrade feature of their function specific software and system for a long time. Normally a special device in the system will hold and manage all the software images. The system software is upgraded when a new version of software replaces the old version of software in the system. By its nature, this kind of filed upgrade procedure is always complicated and normally limited to minor change of manufacture predetermined functionality. In current state of art, general consumers are always been either shut out of the ability for their own features or charged a hefty amount for a new software-defined feature on the same hardware platform they originally purchased.

3. Objects and Advantages

The object of present invention is to provide a new consumer device. When used on telephone system, it can provide a missing chain in the current telephone system. It provides the device with intelligent link control function on the household phone system at a very low cost. It also provides an easy and flexible means to configure and customize the device to meet each individual user's specific needs. The exact same approach can be expanded to other applications with full user accessibility and configurability.

The present invention will significantly alter the way that people live and use of the fixed line telephone system and other information processing systems. Several objects and advantages of the present invention are:
(1) To provide a universal device for transmitting/receiving information to and from phone line.
(2) To provide a universal method of involving the consumer in defining/creating/providing/exchanging functionality to meet his own needs between predetermined information sources.
(3) To provide a device with no maintenance need. People use it in the same way as regular household apparatus. Yet it is easy enough to change or customize the functionality.
(4) To provide a functionally configurable link between regular household apparatus and wired or wireless public telephone network.
(5) To serve as a purpose of intelligent toy, such that children or grown up can exploit their creativity of automatically handling signal on the phone line or other interfaces.
(6) For advanced user, provide an interface and system to create/develop/customize new functionality.
(7) To provide a device that is capable of doing very complicated processing to intelligently create/manage/distribute information carried on telephone line to and from user devices.
(8) To provide extremely low price solution for ordinary household and personal usage.

The invented device will connect the household apparatus and public/private telephone network. It can serve as a receptionist or an intelligent housekeeper. It is to extend the capability and functionality of public/private phone network. The same concept of providing a standard platform with easy to use feature to involve consumer himself in defining the functionality of the device can be applied to other consumer devices. By nature of programmability the device will provide virtually unlimited functionality. Its functionality can be easily altered by customer himself to meet his specific needs. Once the application code is plugged in, the device is operating with no difference than any regular household apparatus, which generally requires no maintenance.

Still further objects and advantages will become apparent from a consideration of the ensuing description and draws.

### SUMMARY

In accordance with the present invention, Phone Computing Machine (PCM) comprises a general purpose programmable device, line-end interface, user-end interface, external memory interface and software function-loader running on the general purpose programmable device. PCM's functionality is defined when user plugs in a portable data storage device containing application software to the external memory interface. In addition, method of providing consumer a general purpose platform with simple steps to create/configure and plug in his own functionality can be applied to other consumer devices with the advantage of flexibility, easiness to use and low cost.

### BRIEF DESCRIPTION OF THE DRAWINGS

FIG. 1 depicts an embodiment of the PCM hardware architecture.

FIG. 2 depicts a line-end interface module embodiment of the PCM

FIG. 3 depicts a user-end interface module embodiment of the PCM

FIG. 4 depicts a flowchart of function-loading sequence that is used with the PCM

### DETAILED DESCRIPTION

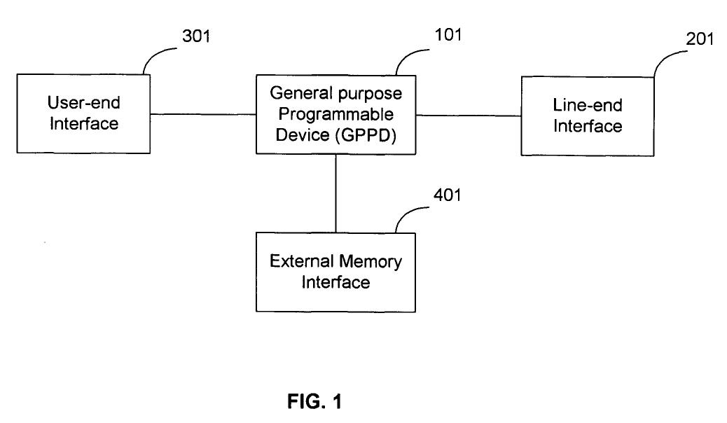

FIG. 1. Shows the preferred embodiment of PCM hardware architecture. Instead of a specific function oriented ASIC approach as used in current state of art low-end device design, PCM will use a general-purpose programmable device (GPPD) 101 as its core. A large category of general-purpose programmable device is a class of general-purpose processor. The general-purpose processor can be a digital signal processor or DSP like Texas Instruments TMS320C54xx or a more general purpose CPU like Intel's PENTIUM or an embedded processor like ARM series. Another category of candidates is in the form of FPGA or CPLD. For those devices the contents of RAM or flash based programmable cells can be changed by user.

A piece of software for function loading resides in the GPPD will load the program/data from the external interface to the execution space and thus the GPPD will execute the program directly. At least part of the program/data memory of GPPD should be re-writable such that a new code/data defining a new feature can be written onto it. By definition a CPU with all code/data in ROM is not a GPPD. Most of GPPD devices have on chip internal RAM as program/data memory for user program/data, in this case no dedicated memory device is needed in the system.

Another approach for function loading is by indirectly update the boot-space or boot memory that GPPD reads during power up, and letting the power up boot procedure take care of the function loading. In this case a memory device is needed in the system.

The use of GPPD makes it easy to change/adapt the functionality of PCM. It gives PCM potential of endless functionality by each user's creative program and usage.

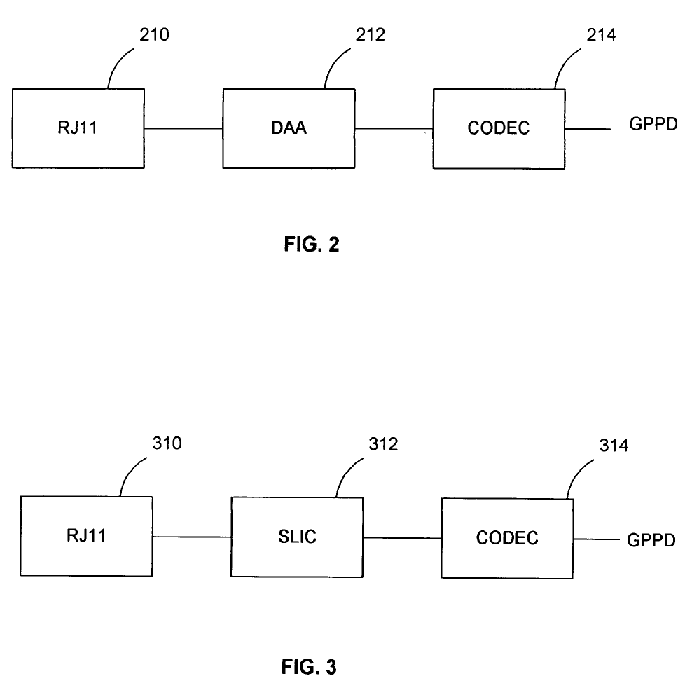

The PCM machine has a line-end interface circuit 201. Through the line-end interface PCM connects to the phone socket of in-coming telephone line. FIG. 2 shows a detail embodiment of line-end interface. The line-end interface starts with RJ11 connector 210 as the standard telephone jack. A Data Access Arrangement module 212 is connected to the RJ11 jack. It is used to interface the public switched telephone network (PSTN). It also isolates the PCM from the higher voltage on the telephone line. A voice CODEC 214 digitize the phone line signal coming from the DAA. The CODEC also converts digital signal from GPPD 101 into line signal to be carried on the outbound phone line.

The PCM machine has a user-end interface circuit 301. The User-end interface can have one or both of the following two features:
1. Analog interface to user phone terminal. FIG. 3 shows this configuration. The analog interface will include a RJ-11 jack 310 to connect to regular telephone user apparatus. Subscriber Loop Interface Circuit (SLIC) module 312 is to provide a 4 wire to 2 wire conversion, send ringing tone and detect off-hook signal of analog telephone terminal. A voice CODEC 314 is to convert the analog user signal to and from digital signal that the GPPD can process.
2. Digital/analog expansion bus interface for non-conventional phone line applications. The digital expansion bus is a standard industrial bus for device interconnection like I²C bus, USB host, Ethernet, RS485 or SPI etc, to connect to devices with standard interface bus. It can also be some non-standard parallel or serial interface to devices utilizing non-standard digital interfaces. In FIG. 3 this expansion bus interface directly connects to GPPD via a driver which is not shown. The analog expansion bus can be served as analog control signaling. In FIG. 3 the analog expansion bus is connected in between SLIC 312 and CODEC 314. It utilizes the CODEC 314 to make analog/digital conversions, but doesn't need SLIC 312.

The simplicity of PCM is achieved by the fixed and dedicated line-end and user-end interface hardware. It doesn't keep the burden of unnecessary hardware scalability and compatibility that current state of art system have. In other words only a predetermined set of user-end and line-end interface hardware will be supported on each PCM. For a user-end or line-end interfaces outside of the predetermine set, user needs to purchase a different PCM platform. The Low cost nature enables it as a more feasible solution for ordinary household. The balance of flexibility with affordability in the application of telephone line system provides functionality and usage that is not available now.

External memory interface 401 is the key of the system. It lets GPPD to read/write commercially available portable data storage devices. One major feature and advantage of PCM is that, the behavior of the device is defined by a software image on a portable data storage device that is plugged in PCM's external memory interface. The software image is a binary file that contains the algorithm code/data to instruct GPPD how to handle the digitized signal coming from line-end as well as from the user-end. This piece of code image will be called application software therefor.

The portable data storage device can be one or combination of USB flash drive, compact flash card, memory stick and any variation of commercially available device for storing digital data. And the external memory interface is thus any digital data exchange interface that is able to access the data storage device. It can be one or more of the following combinations but not limited to
1. Standard USB host interface for USB flash drive, in this case USB flash drive will be the portable data storage device.
2. Standard compact flash card interface reads compact flash card and any variation of it.
3. Standard Ethernet interface, in this case the executable code image is reside in a memory that may not be physically attached to PCM. Ethernet cable in this case connects to a remote PC or other remote memory devices can be viewed as a virtual portable data storage device.

Once a portable memory device is plugged in, GPPD on the PCM will detect the presence of new application software image on its external memory interface, and automatically load the application image into its intended address to execute the new function. GPPD handles both digitized signals to and from line-end and user-end interface. With portable data storage device connected, it can also store important information obtained during any session. Combining those modules PCM can be made into almost infinite functionality.

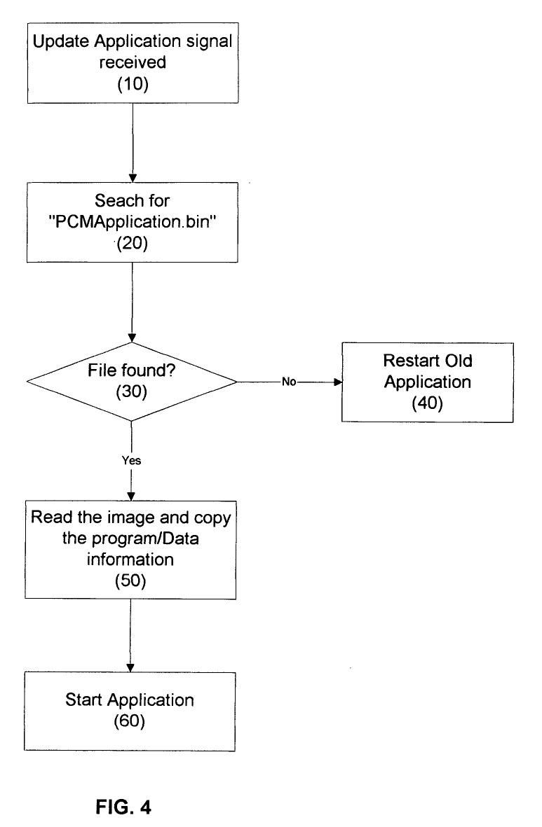

The part of software code that must be present in PCM and as an essential part of PCM is called the function-loader. It loads the application software to PCM. This software essentially gives the function definition of PCM through the portable data storage devices connected to the removable memory interface. The procedure of loading application software can be showed as function loading sequence in FIG. 4. In box 10 GPPD detects the presence of a new connection on its external memory interface and enters this function loading process. It moves on to box 20 to search the memory connected to it to try to find a file with a unique name such as “PCMapplication.bin”. Decision 30 is made on the result of the search. If no such file is found in box 40 the old application is re-started or resumed. On finding the application software image file, function-loader moves to box 50 to read the specially formatted file and copy the program/data information to its designated location. The format of the file is product dependent and should be open to public. Once the loading of application software image is finished, the function-loader restarts the application in box 60 by jumping to the entry of application code, and the user now have his intended function for his PCM.

An optional non-volatile memory may be present in the system, and the function-loader may save a copy of the application software on the no-volatile memory for system reliability consideration.

An instantiation of the PCM will have a DAA module, a SLIC module, a DSP chip as GPPD and two CODECs. The CODECs could be integrated on the DSP chip. A USB driver is needed but you can also find some low-end DSPs with USB driver integrated. PCM will also need a power supply module. A small non-volatile memory is needed on board for function-loader and default functionality, which can be the on chip FLASH for DSP. All those parts are commonly used and under mass production, one can easily find such parts in sub-dollar to a few dollars range. Thus a low cost product solution is achieved.

### Operation

User connects his/her PCM line-end jack 210 in FIG. 2 to the telephone wall jack in home by a twisted phone cable. User also connects the user-end jack 310 in FIG. 3 to phone, fax or other telephone terminals depending on the number of user interface available on his/her PCM. There can be some default functionality on PCM that runs on out of box.

The plug in function feature achieves the flexibility of PCM. In the case of using USB flash as external memory, one can obtain a USB flash drive with a pre-loaded PCM application software. He/she may download from Internet the function need by using a regular PC and save the image on a regular USB memory flash drive. User then plugs the USB flash drive into the external memory interface of PCM 401. On detecting a new USB flash been plug in, the function-loader of PCM finds the application software image on the USB flash drive and load the application software to the execution space. The sub-sequel software jumping to the entry point of the loaded application software will turn the PCM on for user's functionality. Typical user application software will be organized as in the following fashion. It will include four buffers: user-end input buffer, user-end output buffer and line-end input buffer, line-end output buffer. The GPPD takes data from the input buffers, passes data through user defined processing algorithm and puts them into the output buffers. Clock based operation automatically takes data from output buffer, puts them to output interface, meanwhile the operation takes data from input interface and puts them in the input buffer.

The functionality of PCM is defined by plugging in a portable data storage device with application software. An open system structure will make it easy for public usage. Here open means all the system data sheets including schematic, layout, function-loading code and program/data memory map will be available to user or even to public. User can obtain a piece of ready to use software through freeware or shareware or purchase a piece of software from 3^{rd} party. 3^{rd} party or manufacturer of PCM may develop software tools for different users. Such tools can offer user different level of involvement to the functionality of PCM, from merely change the parameters of certain function to merge existing functionality module to make a function module of his own. The making of user's own functionality is relatively easy since it only involves data manipulations between four buffers, while the open source structure can cover the other parts. PCM thus becomes a general-purpose platform as a carrier of endless of functionality and usage. Low cost and open source can be another two major attraction of PCM besides its flexibility.

The following are some examples of simple application with PCM
1. Record every call in standard format in the already plugged-in USB flash. User has the advantage of transporting the record of all phone-call sessions to anywhere, keeping a record, sharing, or post processing on PC etc.
2. Direct all in-coming call to voice-mail unless the in-coming call has a secret code then ring the phone.
3. Automatically detect voice/fax and act accordingly.
4. Reminder and personal scheduler, which can automatically place a call to any number at pre-set date-time with pre-set message.
5. Home intercommunication system using existing telephones and wall jacks.
6. Recognize the voice and remind who the other part is.
7. Automatically assign which line to use in multiple line configurations.

### CONCLUSION, RAMIFICATIONS, AND SCOPE OF INVENTION

Accordingly the reader will see the PCM of the invention can be used easily in everyday life to provide missing links and new functionality in the current telephone system. It has the advantage of
1. It provides a universal platform for telephone based user applications.
2. It provides the data link functionality on the telephone system that is missing in the state of art.
3. It is highly flexible, easily user configurable.
4. It is a device capable of meeting each user's specific needs.
5. It provides a device that allows user to exploit and expand.
6. It is a low cost solution that fits ordinary household use.

While our above description contains many specifics, these should not be constructed as limitations on the scope of the invention, but rather as an exemplification of one preferred embodiment thereof. Many other variations are possible. For example any standard or non-standard interface can replace the external memory interface, code can be downloaded through user or line-end interface via a user specific protocol, etc.

Also the method of providing a general purpose platform and an standard external memory interface with an open structure to give customer the freedom from simply plugging in application software to full customizing application software can be applied to the other consumer devices. While low cost can be achieved by predetermined and fixed interfaces hardware. Examples of such devices are as following:

Voice processing between microphone and amplifier /speakers. A useful application is on the KARAOK machine or high-end microphone system that enhance the user's voice. Another example is the home audio system where line-end interface is the audio source from CD or DVD and user-end interface is the audio cable to amplifier or wireless audio transmitter. For some applications a single low cost CPU will have all the needed peripherals, this kind of simplicity gives great advantage in cost. Besides the cost advantage, this kind of machine doesn't require an algorithm or feature that fits large number of users. It gives more chances for unique flavored applications.

Thus the scope of the invention should be determined not by the embodiments illustrated, but by the appended claims and their legal equivalents.

I claim:

1. A phone computing machine operating between telephone line and local user apparatus/networks/systems comprising:
(a) a general purpose programmable device,
(b) a line-end interface to connect to telephone line, and
(c) a user-end interface to connect to user apparatus/network/system, and
(d) first means for converting signal on said line-end interface to signal able to be processed by said general purpose programmable device, and
(e) second means for converting signal on said user-end interface to signal able to be processed by said general purpose programmable device, and
(f) in combination, an external memory interface and function loading means for loading an user application program from said external memory interface to said general purpose programmable device,
whereby said general purpose programmable device will run the user application program and thereby giving user the ability to configure said phone computing machine to his own functionality.

2. The phone computing machine of claim 1 wherein said general purpose programmable device is a CPU specialized for digital signal processing with RAM based code/data space.

3. The phone computing machine of claim 1 wherein said line-end interface is DAA circuit and RJ11 jack.

4. The phone computing machine of claim 1 wherein said user-end interface is SLIC and RJ11 jack.

5. The phone computing machine of claim 1 wherein said user-end interface comprises a digital connection to user apparatus/networks/systems.

6. The user-end interface of claim 5 wherein said digital connection comprises standard industrial bus for device interconnection.

7. The phone computing machine of claim 1 wherein said first means for converting signal and second means for converting signal are voice CODECs.

8. The phone computing machine of claim 1 wherein said second means for converting signal comprises means for obtaining information from the digital connection used on the user-end interface.

9. The phone computing machine of claim 1 wherein said external memory interface comprises a portable data storage interface and means for detecting and accessing portable data storage device.

10. The phone computing machine of claim 1 wherein said external memory interface further comprises software defined means for accessing a memory block resides in a remote and non-directly connected device through said line-end interface or user-end interface.

11. The phone computing machine of claim 1 wherein said function loading means comprises means for detecting presence of user application program on said external memory interface, and instructing the general purpose programmable to execute said user application program.

12. A method of allowing consumer to have his own functionality in cost effective information processing applications between predetermined information sources comprising:
(a) a general purpose programmable device,
(b) providing means for converting information from predetermined information sources to signals which are able to be processed by said general purpose programmable device,
(c) providing an external memory interface which user can plug in portable data storage device,
(d) providing means for obtaining user application software,
(e) providing means for loading said user application software,

13. The method of claim 12 wherein said means for converting information from predetermined information sources to signals, is a set of analog to digital converter and digital to analog converter.

14. The method of claim 12 wherein external memory interface comprises standard commercial portable data storage device interface.

15. The method of claim 12 wherein portable data storage device further comprises means for remotely accessing data block on non-physically connected general memory device.

16. The method of claim 12 wherein said user application software is a sequence of instructions and data for the general purpose programmable device to perform in its execution space.

17. The method of claim 12 wherein said means for obtaining user application software further comprises:
means for creating and modifying user application software.

18. The means for obtaining user application software in claim 17 wherein said means for creating and modifying user application software is by PC based software tools for coding, software configuring, and merging functionalities to generate the user application software.

19. The method of claim 12 where in said means for loading said user application software comprises means for letting the general purpose programmable device act according to said user application software on said external memory interface.
